(19) United States
(12) Patent Application Publication
(10) Pub. No.: US 2008/0167001 A1
(43) Pub. Date: Jul. 10, 2008

(54) Open Virtual Secure Crosscheck-Link Communication Channel

(76) Inventor: Lim Wong, Lidingo (SE)

Correspondence Address: NIXON & VANDERHYE, PC, 901 NORTH GLEBE ROAD, 11TH FLOOR, ARLINGTON, VA, 22203, US

(21) Appl. No.: 10/568,452

(22) PCT Filed: Feb. 13, 2006
(86) PCT No.: PCT/SE2006/000194

§ 371 Date: Apr. 26, 2006

Related U.S. Application Data
(60) Provisional application No. 60/652,172, filed on Feb. 11, 2005.
(60) Provisional application No. 60/725,000, filed on Oct. 11, 2005.

(51) Int. Cl. H04M 1/66

(52) U.S. Cl. 455/411

(57) ABSTRACT

The invention regards a data and mobile telephony telecommunication open secure cross-link channel (10) system adapted to provide a further level of coding to access code data regarding security data to enter servers (26) for services, money and commerce transactions. A crosscheck is performed in a gateway (12), checking if data belonging to a subscriber, having access code data stored in a memory space (30), is correct by calling the identity and thus the mobile telephony device (22) associated to the memory space (30). The subscriber grants the call and thus a transaction by returning a predetermined signal via the mobile telephony device.

### TECHNICAL FIELD

The present invention pertains to a system and a method in a data and mobile telephony telecommunication and data-network system providing an open virtual secure crosscheck-link communication service channel (OVC), to any service supplier adapted to apply a further level of coding to access code data regarding security data to enter servers for services, money and commerce transactions.

### BACKGROUND ART

The current era of electronic communication deals with information overload—a flood of information from various sources. This has to be handled with efficiency, to avoid “drowning” in information, and to react quickly and appropriately to changing situations—both at work and regarding personal activities. Most information arrives in form of various electronic documents. Data files are created, read, received and sent in differing formats, which are located/stored either on local desktop machines or in case of companies in shared network locations (file servers). Most often, especially in smaller companies, files are placed in pre-defined folders, created by an administrator or by each individual user. These folders roughly define file categories. However, quite often a single document is relevant to many categories/folders.

Moreover, e-mail is currently a common source of information exchange. Many people use it, even though it is unstructured in its nature, unprotected, and very often irrelevant, e.g. “spam”—junk mail. E-mail collections are usually presented as groups of folders, where each folder, either pre-defined or created, roughly defines a category, like Inbox. It is often difficult to quickly find relevant information, even when remembering that it exists somewhere. When computers are utilized at work, or at home, a quick access to various data that is relevant and helpful for the task at hand would be appreciated. However, many times it's hard—even though remembering seeing this information in a document, or as an example storing it in a data file\with\avery\long\path\name.doc or in MyDocuments\Document3245.doc. Furthermore, you probably would remember that there was some sort of e-mail discussion, but it appears that parts of that discussion ended up in various e-mail folders—some in inbox, others in customers, and some in trash.

Standard desktop operating systems contain only very simple and naïve search facilities. Commonly a user is provided either too few or too many results, and after spending several minutes refining a search, in order to finally find the wanted documents, then all that work is lost, because there is no way to save the fine-tuned search criteria, or the search results. That is, if not shortcuts or copies of these documents are created in yet another folder, but this result in waste of space and problems in synchronization, e.g. when files are updated.

There are many full-blown document management solutions on the current market, which specifically addresses this problem. However, they are usually expensive to buy and deploy, and require significant changes in infrastructure and in the manner a user handles documents.

Similar problems exist when working with e-mail. Popular e-mail programs allow even sophisticated searches to be performed, but again, there is no good information management structure—it's difficult to save and modify the search results, to avoid further searching. As was the case with files, a user can make copies and put them in easier to find memory places, but this again results in waste of space and problems in synchronization.

It's even more difficult to find relevant information if a user is on the “move”, visiting a customer, or at home, and then the files on the office file server are not available.

Usually, the user doesn't carry all the e-mail documentation and all files, local and shared, with here/him, and even if so, copies are often not up-to-date. It's too difficult to download all files just to search for that needed—especially in a GSM connection.

### SUMMARY OF THE INVENTION

It is an aim of the present invention to solve problems mentioned and other in conjunction with transactions, and messages sent in modern data and/or telecommunication networks.

Hence, the present invention sets forth a data and mobile telephony telecommunication open virtual secure crosscheck-link communication service channel system adapted to provide a further level of coding to access code data regarding security data to enter servers for services, money and commerce transactions. The present invention thus comprises:

at least one gateway server system, having communication connecting input interfaces to at least one of hardware, firmware, and software connecting any data and telecommunication network operator;

an output communication interface from the gateway server system connecting the data and telecommunication networks to the open secure cross-link channel system;

an interface connecting subscribers to mobile telephony to the data and telecommunication operators, to the open secure cross-link channel system, the subscribers devices for communication having at least one identity to access the open secure cross-link channel system;

a memory space in the gateway server system for every subscriber, the memory space comprising at least all information regarding the access code data, the memory space being associated to the identity;

at least one point for performing the transactions by providing the access code data to the gateway server;

performing a crosscheck in the gateway, checking if data belonging to the subscriber in the memory space is correct by calling the identity and thus the mobile telephony device associated to the memory space; and

if the subscriber to the identity and the crosschecked memory space data, has provided the access code data, the transaction at the at least one point is granted if the subscriber grants the call and thus the transaction by returning a predetermined signal via the mobile telephony device.

In one embodiment of the present invention the type of transaction is performed by utilizing a bank card, shopping card, petrol card, credit card and the like together with the mobile station, the cards bearing the password, wherein other card information is stored in the memory space.

Another embodiment comprises that the type of transaction is performed by a PC or like computerized device.

A further embodiment comprises that the identity is the telephone number to the mobile phone or other identity uniquely identifying the called mobile phone.

A still further embodiment comprises that the memory space in addition to the access code data comprises allowed currency limit and other restricting data for ordering the services.

Yet another embodiment comprises that the call belongs to at least one of the following categories voice, SMS, MMS, data, and that the call and transaction is granted by entering and transmitting the signal of a predetermined PIN code.

Moreover the present invention sets forth a method in a data and mobile telephony telecommunication system providing an open virtual secure crosscheck-link communication service channel adapted to apply a further level of coding to access code data regarding security data to enter servers for services, money and commerce transactions. The method thus comprises:

having communication connecting input interfaces to at least one gateway server system, to at least one of hardware, firmware, and software connecting any data and telecommunication network operator;

connecting the data and telecommunication networks to the open secure cross-link channel system through an output communication interface in the gateway server system;

connecting subscribers to mobile telephony to the data and telecommunication operators, to the open secure cross-link channel system, the subscribers devices for communication having at least one identity to access the open secure cross-link channel system;

storing in a memory space for every subscriber in the gateway server system, the memory space comprising at least all information regarding the access code data, the memory space being associated to the identity;

performing through at least one point the transactions by providing the access code data to the gateway server;

performing a crosscheck in the gateway, checking if data belonging to the subscriber in the memory space is correct by calling the identity and thus the mobile telephony device associated to the memory space; and

if the subscriber to the identity and the crosschecked memory space data, having provided the access code data, the transaction at the at least one point is granted if the subscriber grants the call and thus the transaction by returning a predetermined signal via the mobile telephony device.

The method of the present invention also adheres to the dependent system claims as described above in accordance with the attached set of claims.

### BRIEF DESCRIPTION OF THE DRAWINGS

Henceforth reference is had to the attached figures in the accompanying text of the description for a better understanding of the present invention with its embodiments and given examples, wherein:

FIG. 1 schematically illustrates an open virtual secure crosscheck-link communication service channel in accordance with the present invention;

FIG. 2 schematically illustrates one further embodiment in accordance with FIG. 1;

FIG. 3 schematically illustrates an embodiment for sending e-mail in accordance with the present invention;

FIG. 4 schematically illustrates another embodiment in accordance with the present invention for sending e-mail for connecting to the web;

FIG. 5 schematically illustrates an embodiment in accordance with the present invention for connecting to the web; and

FIG. 6 schematically illustrates how to pay over a network in accordance with an embodiment of the present invention.

### DETAILED DESCRIPTION OF PREFERRED EMBODIMENTS

The present invention pertains to an open virtual secure crosscheck-link communication service channel (OVC) for every cellular phone and the like as well for telephone system operators. The connection to the OVC is accomplished by calling a specific number for that channel, whereby a connection to the channel is routed through gateways controlled by the operators. Suitable multi channel gateways are, e.g. ESDN file type AMR/WAV with voice responder technology and XML gateway, having TCP/IP, and web access interfaces, are available from HP, IBM an others.

Moreover any service provider such as an Internet service provider (ISP), government, police authority, fire department authority, military information department, environment information department or any possible organization which publishes information to the public or closed groups which are connected to the OVC through any suitable communications device such as a cellular phone, PDA, Laptop and the like devices.

Hence, the service providers are connected or utilizing servers to provide information to every communication device connected to the OVC. Every connected communication device such as a cellular phone/mobile station can in one embodiment be provided access intelligence on its SIM card (Subscriber Identity Module card) through a software application, which adapts the communication device parameters to the subscribers preferences for a connection to the open secure cross-link channel of the present invention, and what kind of signals that are available to the subscriber on the OVC. Through the SIM card access intelligence, the subscriber has an own identity to which other ID's are transparent, for example credit card ID's, which are adopted by the SIM card ID and thus the services that the credit cards convey are made available through the OVC of the present invention. Thus, the connected cellular phones, PDA's or the like could be in a sleeping mode and awaken if there is a message for them on the OVC, or on demand through specific time requests or by other possible methods known to a person skilled in the art.

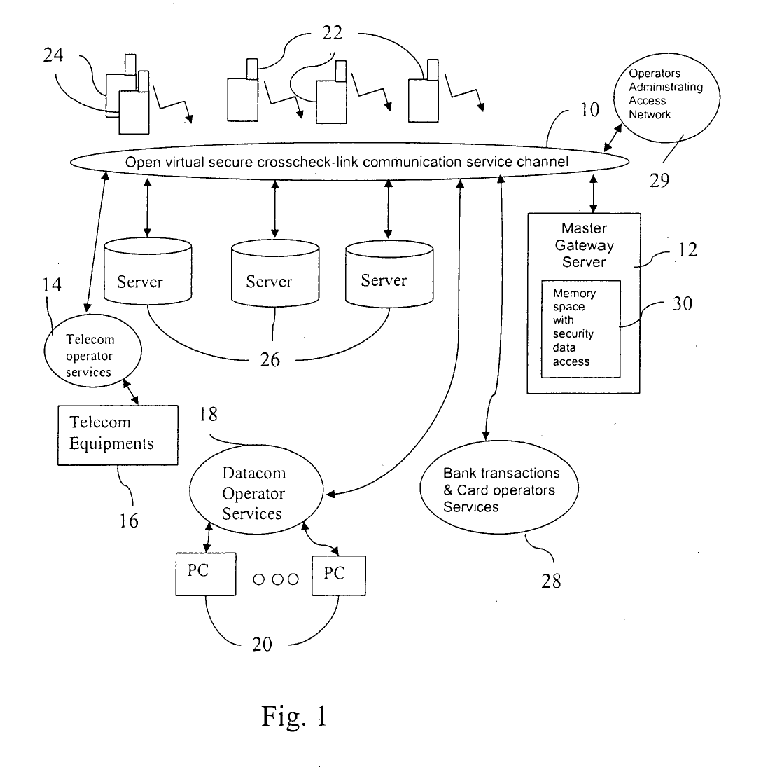

FIG. 1 schematically illustrates an open secure cross-link channel 10 in accordance with the present invention. Thus a data and mobile telephony telecommunication open virtual secure crosscheck-link communication service channel 10 system is adapted to provide a further level of coding to access code data regarding security data to enter servers for services, money and commerce transactions. Access code data in the sense of the present invention could be any kind of data that allows access to systems having security aspects through for instance PIN, password, user ID, biometrics and other like access data. Those codes are used for various devices such as cellular phones, opening of doors, teller machines, access to computers and other kind of machines, alarms, starting and turning off of vehicles, missile launching and other kind of access systems. Hence, the present invention can operate together with the security systems on any current known system. Hence, the present invention secure cross-link channel system 10 adds a further level of access security to systems that already have at least one security code system.

In FIG. 1 it is depicted a master gateway 12 server, which provides access to the open secure cross-link channel 10. The channel 10 itself utilizes existing data and telecommunication networks with their approved technology. The master gateway 12 server is controlling the communication for all connected entities to the open virtual crosscheck-link communication channel 10. The difference lies in that a customer/subscriber to the OVC 10 has to be so to say cleared in order to utilize the open secure cross-link channel. This channel 10 can be accessed through a given code or telephone number. Possible subscribers to the channel 10 could for instance be persons owning a cellular phone 22, 24 or other device including radio data and voice capabilities, and computers/servers 26 that offer services to subscribers in the open secure cross-link channel 22. Telecommunication operators 14 with their connected equipment 16, data communication operators 18 serving computers 20, banks with electronic transfer of money 28 are cleared to be connected to or controlled by the OVC through at least one gateway 12. A customer or subscriber to the networks 14, 18, 28 is provided an additional security level through the OVC 10 by being provided a memory space 30 where all credit card data and information about security levels that the subscriber is allowed to access. Other data then card data could be for instance door passing information, access to specific Internet pages or computers, access to a group of joint members such as police officers, fire fighters, military and any other possible grouping of people joining similar interests. The operators 14, 18, 28 controlling their access to the OVC 10 through an operators administrating access network 29.

To exemplify one application out of many regarding the present invention a payment to a bank account when shopping is used as an example. A customer swipes his shopping card at appoint of sale terminal connected to the open secure cross-link channel 10 to which the shop is connected. The data on the swiped card is transmitted to the gateway 12 and compared and checked with the data regarding the same card stored in the memory space 30 belonging to the subscriber to a cellular phone 22 who is now shopping.

If the data is correctly matched a new security level is added by the present invention in that the gateway makes a telephone call to the subscriber telephone number connected to the memory space 30 in question for the shopping. If it is the card owner who is conducting the payment his cellular phone will ring and he is prompted to grant the buy by entering for instance a PIN code or another procedure to grant the buy.

Hence, it is appreciated that a subscriber who gets his shopping card stolen not will suffer from this because the thief must also have his cellular and a PIN code to make a draw of money from the account associated to the stolen card.

The present invention thus in one embodiment comprises at least one gateway 12 server system, having communication connecting input interfaces to at least one of hardware, firmware, and software connecting any data and telecommunication network operator 14, 18, 28. An output communication interface from the gateway server system connecting the data and telecommunication networks to the open secure cross-link channel 10 system, and an interface connecting subscribers to mobile telephony to the data and telecommunication operators 14, 18, 28, to the open secure cross-link channel 10 system, the subscribers devices for communication having at least one identity to access the open secure cross-link channel 10 system.

There is a memory space 30 in the gateway 12 server system for every subscriber, the memory space 30 comprises at least all the information regarding the access code data, the memory space 30 is associated to the identity. In the system of the present invention there exists at least one point for performing the transactions by providing the access code data to the gateway 12 server where a crosscheck is performed in the gateway, to check if data belonging to the subscriber in the memory space 30 is correct by calling the identity and thus the mobile telephony device 22, 24 associated to the memory space. If the subscriber to the identity and the crosschecked memory space 30 data, has provided the access code data, the transaction at the at least one point is granted if the subscriber grants the call and thus the transaction by returning a predetermined signal via the mobile telephony device 22, 24.

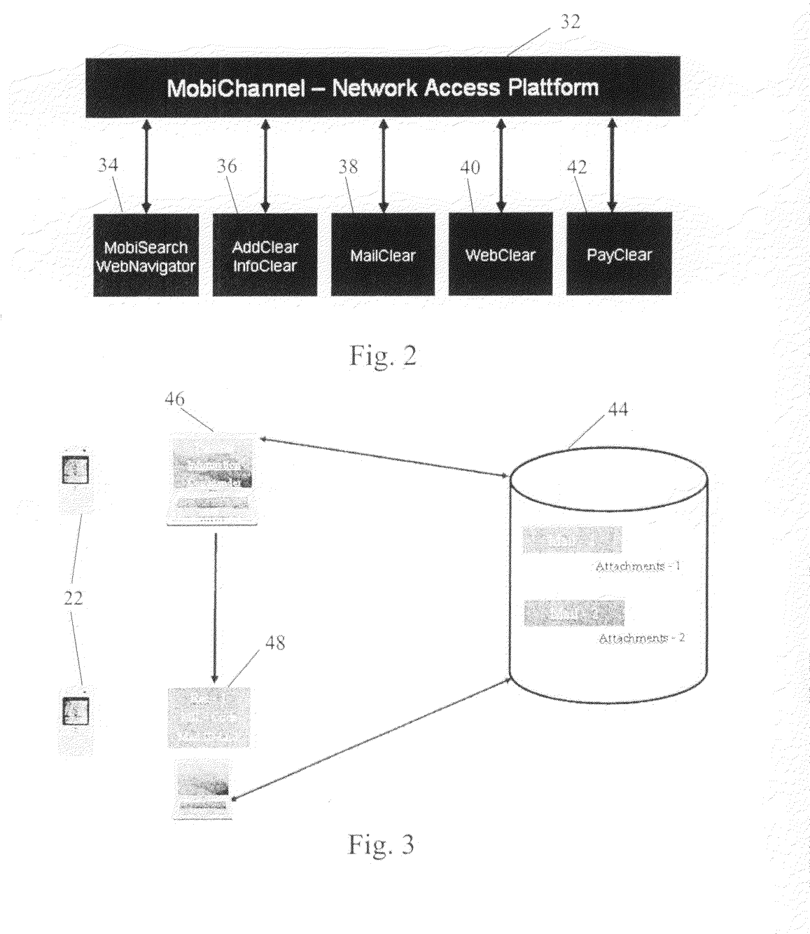

FIG. 2 schematically illustrates one further embodiment in accordance with FIG. 1 where some of the servers indicated as 26 in FIG. 1 are depicted as a mobile search navigator 34, mobile advertising server 36, a mobile mail clear server 38, a mobile web clear server 40, and a mobile pay clear server 42. A network access platform 32 for the servers 34, 36, 38, 40, 42 interfaces the OVC 10 and is controlled by the gateway 12. The servers functions are described in greater detail below. Pay clearing has been explained with an example in conjunction with FIG. 1. In order to access features in the servers in most cases a password/PIN code is required to fetch information or store it. Hence, the present invention applies a further level of security for accessing the servers 34, 36, 38, 40, 42 as disclosed above in the context of FIG. 1.

In accordance with the present invention a search engine named myWorkBase™, herein named search engine is utilized in one embodiment of the present invention to provide information to the OVC. A closer description of the present search engine is depicted below.

In order to administrate the OVC an information administrator (informer(s)) are able to sort out all information that is to be dispatched by the OVC. There exists a plurality of informers as an example a Police Department where every police officer in a predetermined group is connected to the OVC an informed by the informer about a specific task that they are meant to accomplish. For example, if the group of police officers is going to enter a building, they will be provided, simultaneously, all information concerning the building before they enter it. Furthermore they could be provided updates about the building or movements inside it.

Another embodiment of the present invention comprises that the police officers each are provided a radio frequency identification (RFID) tag, for instance attached on their uniform, uniquely identifying each one of them, thus when a message to the group of polices is dispatched over the OVC, the signal from the RFID is received by for instance a blue tooth transceiver and the ID sent over the OVC is matched with the police mans RFID tag, thus the police man receives the information if there is an ID match.

If the present invention had existed when the tsunami of Dec. 26, 2004 hit large parts of land in the Indian Ocean a message could have been dispatched to all cellular phones attached to the open secure cross-link channel by authorities who detected the earth quake that caused the tsunami.

There are few limitations to how the OVC concept of the present invention can be utilized when transferring information to large parts of the population or to restricted groups of people.

The present invention wireless communication is relying on co-operation with other system providers in the area of seamless SMS service and Multimedia servers and backbone networks.

The present invention search engine (info-navigator) can for instance be a central part of two new major projects such as:
1. A public information service supported by 26 EU governments and other public service networks in TV and Radio.
2. A secure cross-link direct channel to be used in Police, Ambulance and Fire services, and like emergency occupations.

Due to the tragic Asian flood Catastrophe mentioned, the present invention system would be a candidate to operate a solution that can access any mobile Phone screen for early warning and instruction in a matter of seconds to millions of mobile phone users. Resources in Europe and other regions are allocated to solve the problem of bringing an early warning system in action. The system of the present invention thus is a part of a solution that can bring a safer world to billions of people worldwide, whatever it matters nature catastrophes, terrorist actions or local accidents.

To be able to test the current beta service version for instance a Sony-Ericsson P900i cellular phone is suitable for testing the system of the present invention.

It is clear that the simple “folder with files” metaphor becomes less and less useful as the amount and complexity of information increases. It forces computer users to become “file clerks”, which spend a lot of time just on file housekeeping tasks instead of productive work. And many persons find in the end that they can't really decide “where is that single place to put this particular matter” so that it's easy to find it later. A new, better information management structure is needed, which allows to collect related items together no matter where or what they are physically.

Also needed are easy to use, yet advanced search and retrieve methods, which allow finding relevant information even if it's not immediately available to us.

The answer to this need is a topic-based data management. It allows keeping truly related items together, and it allows the same items to occur in many categories (topics). This is very unlike e-mail or documents in folders. They occur in just one place, even if they are relevant to many categories (topics). This topic-based approach overcomes rigid structuring imposed by mail readers and file systems. In such topic-oriented structure other relevant information is always close, and other relevant items can be added/edited/modified to fine-tune the topics.

Full-text indexing and automatic classification solves the problem of efficient searching. Full-text indexing drastically reduces the amount of information and time needed to accurately select relevant items. It provides the same benefit as search engines provides Web users—but it also works for personal data.

Classification, on the other hand, is a process of determining which of the existing categories items belong to. Commonly, this step is accomplished by putting a file or an e-mail in a specific folder. This process can be named “manual classification”—users add or remove items from topics, as they see fit. Obviously, this requires a lot of tedious work, because users need to first analyze the item (file or e-mail), determine which topic it is most relevant to, and then file it in that topic. Quite often they find that they need a copy of this item in another category as well. Such manual process is tedious and costly—both in terms of human resources and time involved.

However, in this new, in accordance with the present invention, information management structure items themselves are not stored in topics—only links needed to retrieve them are stored. These links may appear in as many relevant categories as needed. Furthermore, it's possible to perform this classification—putting items into relevant categories—in a semi-automated way, by using Artificial Intelligence techniques. Users are still, of course, able to adjust categories, but the bulk of this tedious classification work is performed automatically. These auto-created categories are arranged into hierarchies, from top-level general topics down to specific sub-categories, and at each level users can navigate to relevant items, which were put there automatically.

These two main principles—better information management structure, and advanced search and retrieve—underlie the architecture of search engine products. The search engine is an information management framework, which uses topic-based data management as explained above, and supports full-text indexing, searching and automatic classification. It smoothly integrates with various sources of existing information, in order to avoid data duplication and re-entering. These information sources currently include: Files in many formats MS Office, PDF, HTML, graphic files, etc., e-mail—local e-mail in Outlook, Netscape/Mozilla, POP3 or IMAP mailboxes, Usenet, newsgroups, Web sites and the like.

Thanks to the highly modular architecture of the present invention search engine, it is possible to add any other data sources, local or network-accessible such as proprietary file formats, corporate databases, back-end systems and others.

The automatic classification module allows users to quickly apprehend new or updated information in natural categories, and to drill down from general concepts into more specialized topics. Users can also use these automatic topics as templates to create their own topic definitions. The search engine supports two major types of topics: Static topics—where users add individual items manually; this is useful wanting to make sure that items will always occur in this particular topic. Dynamic topics—where users define several criteria, using simple keywords or full-blown query language, which are always up-to-date with the current contents of the topic collection.

That is, new items will appear there “auto-magically” if they correspond to the criteria defined for this topic. It is also possible to define “mixed” topics, which contain both manually added and automatically collected items.

The present invention search engine uses unique solutions for language-independent key-phrase extraction and topic detection. This means that texts in various natural languages, including the Asian family of languages, can be processed with good results. It is also possible to augment the algorithms utilized with more sophisticated language analysis through the use of external modules e.g. for translation or further semantic analysis.

The search engine is for instance implemented as a small-footprint Java application, using lightweight components. This means that browsing and editing of these knowledge-bases works on any Java-enabled platforms. Additional features are also available under Windows, to better integrate with the desktop environment e.g. access to Outlook folders and MS Office files. For advanced users, the search engine supports scripting in the seven most popular scripting languages JavaScript, VBScript, Perl, Python and others for sophisticated processing, data classification and retrieval. Preview and retrieval is highly modular—new modules for new data formats can be added based on customer demand. Other user interfaces can be implemented on top of the core of the search engine, or integrated into other applications through the use of Web Services interfaces.

The core information structures of the search engine products use an RDF data model—an international standard for representing information in a Semantic Web environment. This means that the search engine domains can be deployed on one of many available enterprise-level RDF repositories, for better scalability and integration within enterprise environment.

A typical usage scenario is as follows: install the search engine client software on your desktop, define the sources of information wanted to be included in the knowledge-base. The search engine starts scanning and indexing the data, and automatically performs topic detection, classification and the results are stored in a knowledge-base, which is typically 50-100 times smaller than the original source data. Whenever having a need to access specific information, just open the search engine window and either find it by topic, or use one of the previously entered search queries, or make a new query. You will quickly see the item preview, all other relevant items ranked by similarity, and you can also open the original file/e-mail in its native application, if available on your computer. The indexes are periodically updated.

The process of auto-classification can also be fine-tuned to offer better topic management for particular field of knowledge or area of interest e.g. for journalists, researchers, computer specialists, etc.

This scenario works well not only for adding a better navigation to the documents you are aware of e.g. your own document collection. It is also extremely useful for quick analysis of large unknown collections. Such situations arise e.g. during company mergers, when the new mother company inherits legacy documentation, or in computer forensics when investigators need to quickly check suspected content in a more sophisticated way than just by plain text searching.

Other useful scenarios: you can combine the search engine with periodic network backup service, in order to quickly create fully brows able and accessible indexes both of your present and past, historical data. Such a combined service is offered for those customers that want to add flexibility and accessibility to their basic need of data safety.

In such a scenario, users create the search engine knowledge-bases for back-up files. They can then utilize this database to find wanted files—either historical versions, or no longer existing ones—and restore just the files that are requested, thus saving time and disk space for a full restore cycle.

Another scenario: the search engine for mobile users. Imagine that a knowledge-base can be carried handheld. This allows to quickly browsing the database to find exactly the files or e-mails that are sought. Then you have to use a dialup/mobile connection to download just the data wanted. This brings enormous savings in time and costs, as compared with other solutions.

And one scenario that shows the flexibility of the search engine approach of the present invention: topic collections can be prepared by third-party publishers, downloaded and added to your own databases. The search engine then presents a merged view of both your personal information and third-party information—third party topics will provide a structure to present also your personal items when relevant, and your personal topics will contain links to third-party information when relevant.

The search engine family of products according to the present invention comprises two other product lines—a present invention topic-oriented Internet Navigator, and the building blocks for large-scale Internet search engines.

The Knowledge Navigator product enables you to view your Internet search results by topics—using the same principles as used in other products.

Various popular search engines respond to your search with thousands of hits. While this may appear on the surface to be a good characteristic, it often frustrates users who must browse through endless lists of results, many of which are completely irrelevant to the topic they had in mind.

With the Knowledge Navigator of the present invention, however, you are able to quickly focus on the topic that most likely meets your needs, and only then drill down to individual hits. This makes the Internet searching experience quite different.

The Knowledge Navigator uses algorithms for natural language processing multilingual keyword extraction and topic detection. These algorithms can be further fine-tuned for specific document collections.

A Knowledge Navigator in accordance with the present invention can utilize multiple search engines major public search engines like Google, AllTheWeb, Altavista and others. It can also integrate with topic collections (domains) created with search engine desktop tools. Or it can use any other search engine with the utilization of custom connector plug-ins.

A public demonstration of this technology is adapted for service as web-interface on internet and corporate network, as well as a premium subscription service for selected users.

The search engine team managing the engine of the present invention has broad experience in building applications for information management and retrieval. Several custom solutions are offered for building and operating large-scale search engines in the order of billion of documents, operating either as enterprise-wide search services or public search engines.

Indexing the complete Web information is a difficult task, if not an impossible task. Studies show that major search engines cover only a small percent of existing web pages. However, they often fail at providing high quality and exhaustive information on specific topics. This search engine service is applied on the network, which strives to provide a higher quality service, but concentrated on specific topics or web pages coming from specific geographic areas. A public service of this technology is offered at internet and corporate networks.

Also offered are off-the-shelf components for web crawling, full-text searching, keyword extraction, topic detection and document clustering, as well as custom solutions, which meet unique demands for customers.

The search engine functionality is also available on mobile devices, such as PDAs and smart phones. Through the use of the J2ME standard for Java mobile applications search engine, the mobile search client can run on a majority of modern mobile phones and PDAs.

The search engine named MobiSearch communicates with a Knowledge Navigator server, and delivers search results directly to the phone, where it can be saved for future reference. These results are of course organized into topics, so that it's easy to find information even if there are many relevant hits.

The same application framework can be used for provisioning of other mobile applications, such as Internet banking, corporate VPN access, and other client-server solutions.

A public service of this technology is offered—the MobiSearch client can be downloaded directly to any Java phone from an Internet address.

The mobile applications according to the present invention utilizes a special GUI toolkit, which significantly enhances user's experience, and provides more advanced user interface elements than those available on J2ME platforms. The toolkit uses an XML User Interface (XUL) approach to building user interfaces, which enables developers to rapidly redesign application screens according to changing requirements. These changes are also possible during runtime, by downloading new “skins” or user interface definitions—all of this without reinstalling the application. This toolkit is available also separately as a building block for implementing other mobile applications.

The search engine technology enables you to manage your information efficiently and in a flexible way, through the use of cutting-edge technologies like topic maps and Artificial Intelligence. Advanced information retrieval allows you to make good use of your data, even if the original data is no longer available, and even if you are on the move.

Topic-oriented information management drastically cuts down the time and effort needed to find relevant information for the task at hand. Automatic classification saves manual labor, and allows quick apprehension of the main characteristics of large document collections, at the same allowing for drill-down into specific topics.

The search engine can be deployed in an organization even today, as it does not require any changes in the existing infrastructure or in the way currently handling information. However, by providing a high-quality interface for information-intensive tasks it will revolutionize day-to-day work, free from spending hours emulating a “computer file clerk”, and enabling to work the way you would like.

The search engine enabling technology is a commercial product with a suite of solutions that rapidly can adopt to meet the needs of commercial operation in different business applications from general Internet search to specific customized solutions.

In the present Internet and Media world new demands appear regarding development of mass applications for Publishing, Marketing, Sales and information services. Existing solutions are mainly based on the experiences created as an offspring from printed media. The “document” and “page” oriented solutions for storage and “mail” distribution of information have impact the way the existing Web, e-Mail and Internet communication is utilized.

Within the last few years the power of Internet as super information source is demonstrated by the way the search engines are developed and utilized and valued on the stock market. Billions of end users and multibillion of web-pages and the new era of billions of smart-mobile phones has created a turning point for printed media to enter the power of Internet. That fact creates new demands solving general problems like, virus, spam and payment frauds as well as the available space.

The Project named MobiChannel, FIG. 2, mobile channel as a working name approaches this problem by enhancing intelligent information gateways to “one free media and communication service channel”, and a new optimised user oriented solution for the building blocks of service that is the playground for the next generation of users related to search, advertising, publishing, e-Mail, web info and payments. Creating a new media channel for printed media, Internet, TV, and mobile phones integrated to one Global interactive network.

Mobile channel is a concept that can have an impact on everyone that uses credit cards, e-mail and web publishing. To explain in some detail but first of all to provide an approach of the mobile channel project, the “one channel approach” of the present invention. The mobile phone market today is fragmented into many different arenas, which are named operators. What can be achieved is to unify all communication in one channel—free of charge—by utilizing the screen of the mobile phone. That screen will be used as a direct channel of advertisement; information and services while the voice communication for instance is free of charge.

The MobiClear™ channel, mobile search as working name, concept offers the opportunity to use this channel free of charge, no more bills. Just call as usual but having advertisement for instance to the right on the screen. It is possible to also use it for early warning systems so if something very important happens, like for instance a tsunami, mobile clear channel can display a warning for all members/subscribers. It will be possible to synchronize all the more than one billion phones in use today into one type of signal and one kind of message. This means that a warning signal could be sent to all mobile phone owners without interference or hand clicking because it's a prioritised channel to the screen.

The mobile clear channel according to the present invention offers the opportunity to service all people in the world with communication, including full Internet capabilities and personnel communications both ways. Consider having 3 or 4 billion people unified in one network, free of access, thinking of the communication that can be established on that level. Now it is possible to group it in many directions because it's open and free, like Internet itself. But it's paid by the way the customer uses the services.

There are ways to support this approach, in accordance to the present invention the mobile channel approach. It is possible to connect services onto this channel just like currently on the Internet, but the difference is that it is provided free of charge. Then the first level MobiSearch™, mobile search as working name is actually searching Internet free in any direction, with any search engine. And it comes out like it does now with banners and ads, but also with new personal information of interest. For instance, when a customer reads a newspaper and sees an ad and is interested, currently customers take their pen and start adding it to their calendar or ripping it out of the paper.

One of the services/applications in mobile channel is named the MobiClear Ad™ or MobiClear Info™. For this service the customer finds the ID number in the ad and enters it in their mobile phone. Then all the information about this ad pops up on their screen. They can click for more information, call or save it into the internet or whatever they want, all in their hand, now unifying the paper media with Internet by using one device, the mobile/cellular phone. When the customers are at home they can view this saved information on their computer.

Another matter to consider is, when looking at the current web today, what is the major problem? Spam and virus. It is the most costly threat against good use of existing information services. Why are the problems so big? One of the reasons is found in history, how the Internet developed. Back to the time where there were small Internet messages that were transported via Internet. Then web pages arrived where people could share with others and collect information. But then it expanded beyond the idea of using small short messages to overloaded information with attachments, gigabyte of information in many different traffic directions.

Hereby, it is sent just as with traditional mail. Taking bags/bulks of information, copying it, putting it in envelopes, and sending it forth. Each person is provided with one copy, because they are not interconnected. Each of them gets one own copy. But actually it can be stored on one server and the rest of the world can read just that document. Why should you send a copy to all of them? With only one click it can be read on the computer and shared by millions of users. But that is not utilized because the history of the internet, how it has developed, did not fore say it.

With MobiClear Mail™, mobile clear mail as working name, small ‘key numbers’ can be sent to the ones that will receive information from the sender. With these key numbers the redundancies of attachments are cut extremely. The customer can also set security levels on who is allowed to see the information that they have stored. This is the MobiClear Web™ approach, mobile clear web as working name.

There are three Clear levels MobiClear Web™, MobiClear Mail™ and MobiClear Pay™ in accordance with the present invention.

The concept of mobile clear web is that, doesn't duplicate information, or refer the information and open it. With that in mind a lot of other things can be accomplished. The customer can, for example, organize information of knowledge and use the search engine to view them in a personnel web page.

Now the customer doesn't have a mailbox but they have information services based on the most common instructions on the web at web pages. Sending information through the web to friends and associates isn't a matter of sending billions of copies; instead it's a matter of accessing that one copy that the customer wants to share. This concept can also be put in to the “mail world”. When customers have an inbox, they get an extreme amount of information in the inbox. They must check who is who and make a decision who they can trust. If they guess wrong they have a big risk of spam and virus or losing valuable information.

With mobile clear mail, if a person wants to send something, the receiver responds automatically and asks; “Please fill in this little form before you send it, who you are, the priority, and some category and why you are sending the information to me.” That little slip will be a form that mobile clear mail requests from anyone that wants to be a part of sending information to the receiver. Now the e-mails received in the storage area are stored and viewed by category, instead of the traditionally inbox e-mail. Of course there could be an alert function that comes up on the mobile phone or to a special web page, as an express web page for urgent messages.

Information is now actually sorted in categories instead of inboxes. But the database can be sorted in many different directions of sorting. That also means that a customer can view it on many devices because web pages are easy to modify in the XML standard. The concept of complete unified information exists. When a customer wants to look at his/her web page, he/she can have a protective layer so no virus can get into the system because it is viewed in a ‘tunnel’ to the web page wherever he/she is.

The servers—that are a customers' partner to hold all information—should be controlled and super shielded from the dangerous information on the Internet. Now the availability, simplicity and opportunity to manage under a very controlled way the information that gets to an available costumer is at hand.

Illegal documents are immediately detected, and customers can also, with mobile clear mail, have the request coming to the mobile phone/cellular phone if they want to set up rules. But there is no need to spend hours trying to sort and file incoming e-mails, because there is a clearly defined inbox on your own personal web page. Each e-mail goes to a predestined box assigned by the sender.

The next step, an important step, is the MobiClear Pay™ system of the present invention, mobile clear pay as working name, which answers one of the most common problems countered, fraud with credit cards. The credit card is a fantastic solution; you can use the card and pay without carrying a lot of money. The customers can identify themselves and can accomplish a lot of things with the card.

The major problem is if the card, even if they don't have your pin code, they can use it by fraud because it is protected only at the card level, i.e. account level. But in reality the problem is not on the card level, it's on the transaction level. If someone takes the card and uses it, utilizing the owner's card number to be authorized, then the transaction will be accepted because it is accepted on the card level. The problem has its roots in history again, how the card system was developed. When the card came out on the market there was no real “online”. It was a slip in the beginning, which was then sent in. The transaction would be processed, maybe, one month later. There was no real relation between the transaction and the time of slipping the card. The customer had to check the transaction for accuracy one month later.

Currently there is a much more advanced electronic network in place. Transactions created by electronic card reader terminals are travelling around the world in a few seconds. Anywhere in the world you can draw your card on the account and within seconds, it is updated. So why waiting a month to check if that transaction was good or bad? It can be done right away. The only protection level seen so far on the card is that the pin code was not valid or there was not enough money on the account. If the problem is only the lack of funds on the account, most often the transaction will be confirmed anyway. So that leaves only one real level of protection, the pin code.

Now let's consider the social problem. Because there only exists one-manner to stop illegal transactions before they happen. If someone has stolen a card, or if the customer is missing the card, his or her only option is to make a call and cancel the card. One click and the card is non-active and can not be utilized again. They must wait a week for a new card to be issued. Let's imagine that the customers can control the cards availability when they want to The mobile clear pay system now creates a controlling system in front of the banks, and the first matter to accomplish is to utilize the mobile phone to identify the transaction. To start with in the mobile clear pay system the phone is cloned to the credit card. This was depicted in the context of FIG. 1.

When customers want to have a mobile clear pay service installed the customer grabs the mobile phone, going to any card reader terminal and asks for that he/she wants to have a mobile clear pay connection to their card. Then the customer enters the phone number and charging limits. A monthly or a yearly fee is charged. To open the transaction services on the account the customer is provided an ID number, which is registered, on the mobile phone in a special SMS page. Now this card is cloned into your phone. The active number that relates to the first purchase on the mobile clear pay subscription comes by an account statement. At the time when the customer can open the account statement he/she will find the activation code to be entered in the system and the mobile clear pay phone is active. Now he/she has the capability in hand to control when the card is “alive or dead”. This is only the first advantage of the system, because when the card is put in the customer's pocket, it should not be active. They can rather say, “Put it to sleep,” by a click on the mobile phone, the card is ‘sleeping’. A thief can take your wallet and run away and try to use the card but it will be dead. There is no way to do any billing.

If the customer wakes up and walks to the hotel bar and wants to buy something showed on the cellular phone screen, then he/she ‘clicks on’ their card, and activates the card back to life. In a few seconds the card is alive again. Now the customer can use the card for mobile clear pay services. After a couple of seconds the transaction shows up on the phone and the customer can accept it by entering his/her code, and now the transaction is accepted. The transaction is sent into the storage systems, the bill is accepted by the seller, and now waiting to arrive at the bank, because the customer has cleared it with the phone.

The customer can of course say, “I want to do something more, I want to send information to the account services on my companies. I'm travelling and I have a travel report to do”. In this case the customer registers the account number and saves it with the co-operator. Now this message is sent to a web page in the customers mobile clear web where he/she has all the transactions listed by shops, by time or the way they like. They can sort them and talk to the seller another day when they arrive at home or when they look in the web pages.

Now the customer controls the transaction. When they are done with it and the bank also has accepted it, both then can forget it, because now it's checked and correct. If a customer wants to manage something else, they can open their web page and say, “I want to click on these transactions and put it into my report and request the money from my company.” The customer has complete control of the sequence, from the second where they put the card alive, they control the transaction; they control the directions of what they want to do with the bill, and the receipt.

Subsequently, the customer can wait for a request from the bank, sending a bill. They are sending a verified data. It's time to pay. Accept and pay the bill. Hence, the customers are provided everything electronically. At any time they can go back and open their web page and have an account check, see the shops they bought from and go directly into the shop again. The customers now have a complete monitoring of the transaction flow. That makes mobile clear pay a fraud controller, because no one can do anything with a card if the owner of that card has not agreed by the phone. Another benefit is that the customer can put a time limit in the card. In other words, if they haven't done any transactions in a limited time were no transaction is connected to the card, automatically changes its status to ‘dead’. So they never have a living/active card in their wallet.

The ‘marriage’ between these two areas is that the customer controls the situation. Let's say. The customer gives the card to his/here daughter. She goes out shopping, and the customer lets her use the card. Then the customer opens their web page, with the mobile phone or Internet, entering information about the card and says, “Today this card is only valid for SEK 500 and only in these three shops.” That means that the customer gets the message by phone when the daughter attempts to buy something. The customer can say yes or no. He/she can control the transaction remotely, and of course also add mobile clear pay to his/her phone as well, so both the customer and the daughter must validate the transaction. With this in mind it can be seen how the concept works. The customer can control all sequences of a transaction.

Next step could be that mobile clear pay will give the opportunity to the banks to sell a new service, right away, because if the customer is the owner of a Visa, MasterCard or another card it can be assigned to the mobile clear pay system. Now the merchant or the bank can sell the service and earn money while saving costs, and everyone that has a card reader terminal can sell the assignment to mobile clear pay service. Because it is just an “add on” product. Sell and go.

Moreover, to another opportunity, like Statoil® for example they have 1.2 million card users in the Nordic countries. They can now—with the mobile clear pay—be advised about sales, special promotions, or new services being offered. They can be provided a special offer because they have a customer relation. When costumers are buying gasoline they actually click on their mobile phone and choose the pump they want to use. They pump the gasoline and do not have to visit the station. And of course one can do parking and a lot of other services utilizing this system. The customer is now controlling the card with an on off situation, following the transaction until the ending of a transaction and automatically adding other accessibilities of services.

Until now the card is beneficial, i.e., to have as an extra function because the existing clearing network 28 is the most extensive electronic network beside the internet and it is distributed thru out the whole world. Mobile clear pay utilizes two separate networks and adds a third one—the mobile phone network, Internet, transaction network, and mobile phone—three networks that interact. That means a more than triple security level. Thus this concept can be trusted and the customer decides the level of it. Mobile clear pay eliminates the fraud problem very quickly.

There are still opportunities to do frauds but it's more complicated. To avert this, the customer can add other features that will protect the transaction. For example, if someone is taking your card and tries to use it, then the card owner gets an alarm that someone is using his or her card. With mobile clear pay it is possible to send a signal to the seller that the person who is trying to buy is not allowed to use the card and that he/she should be denied using it.

MobiClear Pay™, MobiClear Mail™ and MobiClear Web™, are unifying the control to the end users and making it still very easy to manage. The combination of protection while being easy to manage is only a communication problem. With these systems all kinds of unwanted activity can be halted.

Added to the service level on the phone, there is a search engine. The search engine has to have a gateway to the most important descriptions of this so called free mobile channel system. With operators being partners, they can sign up as members of the free channel. Because they provide their network free of charge in this services. In return all the phones that are used in the network are logged, and the kind of income they generate. Some percentages from incomes arrive from clicks, SMS, Music and other activities in the mobile phone other than voice, and will be provided as commissions to the operator. So instead of sending a bill the operators get the profit for the services.

The log system and the gateway must have an identity to inform everybody how they used the phone for this kind of services. While otherwise it's not about the small bill company but mostly a no bill company. But of course it's a case of development. First of all a data network is established, the service gateway and the free channel in accordance with the present invention. And Further service providers are added, which match the network. The next is to explain the level of the structure, and what is providing the functionality.

The mobile clear channel principal is that each operator and user is a member/subscriber to a gateway; this gateway 12 is an access point where you can visit other telcos, to service providers, and IP-providers and other providers. The gateway 12 is the mobile clear channel gateway thus knowing by the OVC that this special gateway is the partner ship gateway 12 so whatever happens with a phone now is logged by this gateway then you can utilize the services. That means that you have to have a mobile clear channel administration network, that actually can make accountings of activities by the ISP-relation, the internet providers, and account controller where every activity for the specified device can be logged in different kinds of billing, i.e. search engine click and so one, there are some accountability that must be accomplished.

Billing services that summary the services providers that use the channel they want to get paid by, the way they deliver services to the end user, and then there is a billing services opportunity. Here, the phone is utilized as a payment gateway, mobile clear pay for example, it means that mobile clear channel 10 then has complete free access to any banks and other service providers opportunities. The credit cards or other payments service providers can utilize the channel 12 in whatever level they want and you can add other service networks into the system. That is an importance of the gateway.

The gateway 12 has the account control of every phone, but you can also send messages of different kind to the network. That means that governments can utilize what herein is named an Early Warning, which means that all phones in the system could have the possibility to have the society network for early warning or other information. The phone is allowing the screen to be updated with any interruption if there is any important information. A government will pay fees to the network to make these possibilities available. The Early Warning system can be activated in different levels, i.e. country or city.

It must be discussed and decided how these account levels will be checked out, but the basic level of this is the phone number. The phone number (with the country code number) is the ID hanging on the base, as this number will be the most unique number in the world. Then there is a basic account and you can read which operator it is. Information you see “on the fly”, reading a newspaper or you are walking on the street can easily be saved with MobiClear Ad™. The ‘owner’ of the ad must be a partner of MobiClear Ad™. In the end of the ad you've had a short cut number that provides information about the ad. All members of the MobiClear Ad™ can send a copy of the ad's identity to a database, and everybody can collect the data but only store the short cut number.

In the future a photo can be taken of that ad and OCR will turn it into an access number. Up on the screen the ‘click’-part of that information is received. In one embodiment of the present invention the newspapers also have information on an article and the news and they request an identity number underneath of the ad you have a contact number and you just ad that number to your phone and get the latest updated news on that article. As well as you can send this information to friends and others.

This means that the printed media will be a part of Internet media interactivity with MobiClear Ad™ functions. Ad and information clearing services is a very important network task. Many times you are passing by and don't have the time to note things from ads or rip out from newspapers or bring the newspaper with you home and then try to remember where the paper is and on what page the interesting information was. Hence, now you only ‘click’ ones and you will remember it, sending that information to a mobile clear web page.

Mobile clear mail is based on the fact that the gateway can be utilized in any mobile phone. An OVC can always utilize the connectivity and viewing the mail as easy as with a standard Internet connection. The sequences involves a gateway or a server for mobile clear mail where you can store the data in a service centre and a replica can be sent to a personal computer and then have it in control in accounts on the mobile clear mail server.

The sequence is the following: If anyone sends information requesting actual information in a mail, it arrives to the mobile clear mail server and is stored in the service centre, sending an acknowledge message to the receiver stating that “I want to send you this information”. If the receiver is a part member of the system, he/she has already predefined the format you request and gets access to send information or services. But if it's the first time the service will send back a request to the sender to fill in the forms before he/she can let the receiver accept the information. That's why the request path is always there. If anyone one then wants to view the data on the mobile clear mail server he/she must use the access code from the mail system to open it on the web site instead of having it stored in his/here own local area.

This is a “ping pong” message in the communication between the sender and the receiver because no one can really directly send something to the receiver. The mobile clear mail server is controlling everything. If there is storage of attachments in the server anyone who wants to see it must have the access code to see the information, instead of sending it anywhere (to all receivers) on the internet.

FIG. 3 schematically illustrates an embodiment for sending e-mail in accordance with the present invention as a ping-pong message. Customer laptop 46 sends an e-mail 1 or 2 with each one attachment, to the e-mail server 44 where it is stored, and the customer laptop 48 fetches the e-mail 1 by entering his access codes, record 1, MIL-code, and Mail ID-Link. Subsequently the owner to laptop 48 subscribing on one cellular phone 22 subscription is called by the OVC 10 system to get a grant for the subscriber being the correct person to fetch e-mail 1 from server 44. Thus there is added an additional security level upon the existing.

The gateway 12 of the mobile clear mail is an important feature. The gateway can utilize the gateway on the mobile clear channel any information from the mobile clear mail server can be copied to a mobile phone 22 or personnel computer via internet with specific high protection protocols. Whatever that is located locally in the company or it is a public service is other matter, but it is still the same concept, duplicating the document and sending it fully loaded to the computer before it has to fulfil the requested information.

That means actually that when you're establishing it, a group of small sending forms is created. When a mail is sent to any person, a form has to be filled in and then sent to the receiver. This form will identify the sender, and it will be authorized and stored on the mobile clear mail server. The receiver is viewing what the sender has filled in so when he/she views the mail he/she already know what the sender wants to say and this is a classified situation. That provides the benefit that the sender has the burden to sort and organize the information, and not the receiver. If the receiver currently has 200 mails he/she must do all the work to sort, bring it back, delete it, responding and trying to priorities etc. That burden is now in the hand of the sender. The sender is only allowed to send because “he/she has a message to a person; please fill in this form so that I can organise my incoming mail”. There could be more information as “When do you expect a response?”, “Do you expect a response at all?” etc. or other types of standards situations.

It becomes a kind of standard, and it will abort costs. With this in mind one or two hours of work has been saved that mostly everyone, as for instance let's say Ericsson—thousand of employees—have to sit and spend every day just sorting things out. Now it's placed on the sender side.

Now cluttering of the Internet with a lot of attachments is deleted, because its points to a single copy stored in the gateway server. Another good thing is that contact information, if sending information to a member of mobile clear web, will update the own address book. While sending you have an opportunity to click and update the address book. When receiving the information mail, you will have the latest information of the sender's information, address, contact, name etc. It makes the address book perfectly updated all the time. Now it's really a contact services that automatically deals with the situation. This is what it's needed to be accomplished: take away the extremely complicated way of how the users today manage incoming mails, and there could be a possibility to flash the message to the addressee and even place an alarm on the mobile phone. That is why the mobile clear mail is clearing the relation and information and clearing distortions.

The following product is similar to mobile clear mail. Its working name is mobile clear web because it's about information services that a customer has an interest in. When the customer views a search he/she has run on the Internet, he/she has probably interest in information he/she wants to share with others. Then it is possible to create mobile clear web storage in the gateway where the information stored can be connected. For example, if the customer has information that he/she wants to remember then he/she has web pages that are dedicated to the subject of interest. Click on different kinds of interest and move them into the personal mobile clear web pages where this data is stored. It could be anything from special matters like golf, music or a company's special information. No need to store the links in the mobile clear mail. In the mobile clear mail, the customer saves information that you his interacting create or very personal messages.

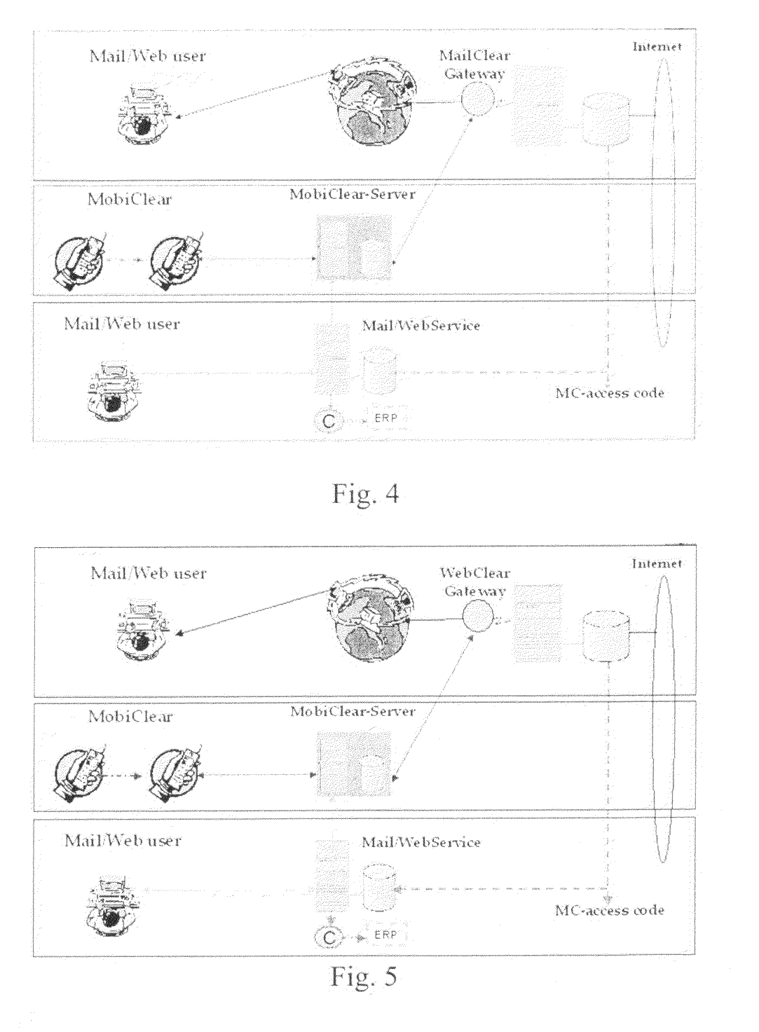

In FIG. 4 the concept of mobile clear mail is schematically depicted, wherein the access to the mail server is handled in accordance with a similar procedure as described in the context of FIG. 1.

About web pages publishing oriented information that the customer collects because this area is of a special interest for him. The customer could turn to one web page to monitor all the information regarding a special subject and the search engine updates the information to the customer.

The customer can have his own publishing system. If a customer wants to share information with others he/she can provide such pages ‘open’ and everything is stored on the mobile clear web gateway and he/she can send a link to all friends instead of adding a copy into the mail or send the information as an attachment. The friends can click in with their phones 22 and take a view at the information. But still it's the “owner” that control's the information.

The customer can now send out a list to people that he/she knows. And he/she can click ‘on them’ and then directly talk with them. In that way mobile clear web is a subject of interest that the “owner” collected from a series of web pages. The owner could also ask the members for comments, he/she publishes something and sends out a list and now knowing that these people can return and comment that information.

The customer can also utilize the mobile phone to interact with web pages, updating the web pages with new information. It is also in the picture, with the MobiClear Ad™, which is a new service for newspapers. With MobiClear Ad™ the customer actually can grab his phone and collect information and store it in the mobile clear web on a predetermined specific page.

In FIG. 5 the concept of mobile clear web is schematically depicted, wherein the access to the mail server is handled in accordance with a similar procedure as described in the context of FIG. 1.

The first step is—once the customer has accomplished the initial start up sign in to the system—is to wipe the card and the system will validate it through the phone network. When the connection is established it enables the customer to where a transaction, utilizing the “on off” function and there will never be an active or “living” card in your wallet. The card is dead until the customer activates it.

When the card is “on” or active, and the card is wiped, the system acquires the gateway 12, checking the card owner's account and accomplishes a verification of the transaction to the bank system 28. The bank system now knows that this card is valid but there was no transaction, because the gateway is holding the transaction and asks for verification and accomplishes one or multiple verifications on the levels you want. The card will automatically change status to “off” or non-active after a predefined time.

If the transaction is approved then the verification is registered in the gateway server and stored. There exists a temporarily account-No., where small transactions can be loaded before the card owner visits the bank and receives the full advantage. But it's always checked that the card is valid. You can store small transactions and then after it's filled out you can automatically load it from the bankcard into the present invention system. There exists an opportunity when a bank sends information to customers Internet accounts that an account owner can check and verify. All the transactions are already stored in the personnel mobile clear web pages that can be seen in mobile clear web pages with phone or Web and there will now be a “no bill” situation. If the two transactions are in match, then the costumer can say “yes” and the bill is verified. There is no need to go back in and check the transaction. That means now that the billing system is basically removed from the bank side. The requirement of the bank is that the sum of the outstanding account is equal to the account owner mobile clear pay amount.

With this system, it's possible to open a web page and view personnel mobile clear pay accounts and actually finding the phone number to the sellers directly from the transaction part. That is an important after sale situation. If every vendor actually can put ads to the transactions they have performed through the card, means that the costumer now can be informed if there are extra sales and if he/she is interested make a “click” and buy. The costumer will have an extra bonus because he/she was a customer before. The whole bonus system can be built in the system. And now it's not only pure transaction or safe transaction but actually it's a customer relation system. You can return anytime and view at the web site if there is a transaction, and that you have been buying. That means the possibility to sell costumer services systems to the vendor. Out of this it is possible to sort out a complete customer relation services as well, which can be named a data warehouse. mobile clear pay is a complete match of everything from security to relation and marketing services.

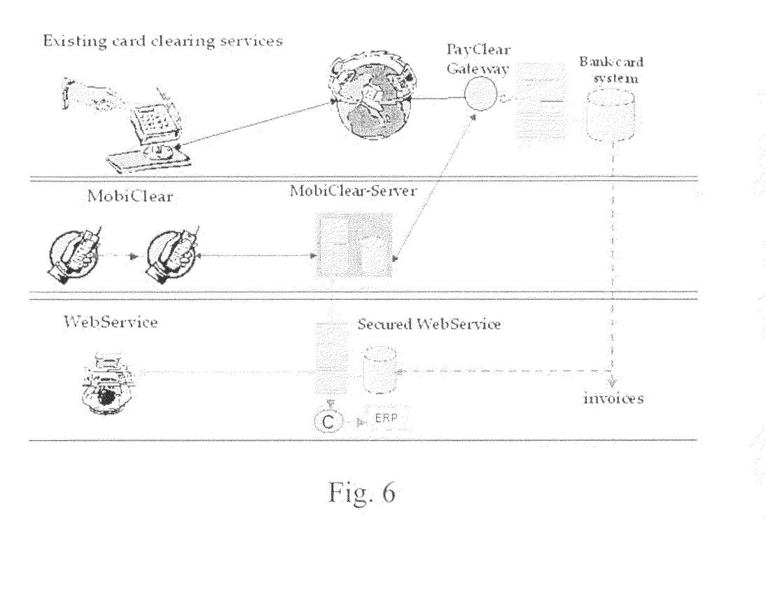

In FIG. 6 the concept of mobile clear mail is schematically depicted, wherein the access to the mobile pay server is handled in accordance with the shopping case described in the context of FIG. 1.

This provides a universal mobile search and access channel and an intelligent service gateway for network integration with service providers and operators. Licenses joint venture revenue share system with operators and Integrated service applications such as MobiSearch™, MobiClear Ad™, MobiClear Web™, MobiClear Mail™, MobiClear Pay™, and there is further Global application for MobiCitizen™ and Early Warning services. The MetroSearch™ project for multi channel media application. This provides a new standard for integration of Internet search engines, mobile phones and printed media. The traditional content provider for the masses based on printed media so far mostly copying their information to be available in the web format letting the search engines make business on their content. Similar approaches are also taken by TV-media.

But there is a missing income link especially for printed media with traditional revenue based on advertisement and paid information. The direct connection with the printed information and Ad content and the hits at the Internet search engines result. For a newspaper, which mostly is read on the fly, the content on the web will be read separately from the paper version. Solutions that will create a new dimension in revenue streams are offered by the present invention web navigator—providing control of the search engine result specially both for a newspaper itself and on Global basis, the mobile search, Makes the mobile phone a direct information navigator with a free data channel, the MobiClear Ad™—giving Ads and content a short-cut Id number for direct access on Mob. & Web, and the mobile clear pay—creating a complete payment solution for content & products on Mob & Web.

This solution offered by the present invention will form a new business area that can reach a value in line and above with the value of the current leading Internet search engines.

Although, the present invention has been explained through examples and given embodiments, the present invention is not limited to those, but to what a skilled person can derive from the attached set of claims.

1. A data and mobile telephony telecommunication open virtual secure crosscheck-link communication service channel (10) system adapted to provide a further level of coding to access code data regarding security data to enter servers (26) for services (34, 36, 38, 40, 42), money and commerce transactions, comprising:
at least one gateway (12) server system, having communication connecting input interfaces to at least one of hardware, firmware, and software connecting any data and telecommunication network operator (14, 18, 28);
an output communication interface from said gateway server system connecting said data and telecommunication networks (14, 18, 28) to said open secure cross-link channel (10) system;
an interface connecting subscribers to a mobile telephony device (22) to said data and telecommunication operators, to said open secure cross-link channel (10) system, said subscribers devices (22, 24) for communication having at least one identity to access said open secure cross-link channel (10) system;
a memory space (30) in said gateway (12) server system for every subscriber, said memory space (30) comprising at least all information regarding said access code data, said memory space (30) being associated to said identity;
at least one point for performing said transactions by providing said access code data to said gateway (12) server;
performing a crosscheck in said gateway (12), checking if data belonging to said subscriber in said memory space (30) is correct by calling the identity and thus said mobile telephony device (22) associated to said memory space; and
if the subscriber to said identity and said crosschecked memory space (30) data, having provided said access code data, the transaction at said at least one point is granted if said subscriber grants the call and thus the transaction by returning a predetermined signal via said mobile telephony device (22).

2. An open secure cross-link channel according to claim 1, wherein said type of transaction is performed by utilizing a bank card, shopping card, petrol card, credit card and the like together with said mobile station, wherein other card information is stored in said memory space.

3. An open secure cross-link channel according to claim 1, wherein said type of transaction is performed by a PC or like computerized device.

4. An open secure cross-link channel according to claim 1, wherein said identity is the telephone number to said mobile phone or other identity uniquely identifying the called mobile phone.

5. An open secure cross-link channel according to claim 1, wherein said memory space in addition to said access code data comprises allowed currency limit and other restricting data for ordering said services.

6. An open secure cross-link channel according to claim 1, wherein said call belongs to at least one of the following categories voice, SMS, MMS, data, and that the call and transaction is granted by entering and transmitting the signal of a predetermined PIN code.

7. A method in a data and mobile telephony telecommunication system providing an open virtual secure crosscheck-link communication service channel (10) adapted to apply a further level of coding to access code data regarding security data to enter servers for services, money and commerce transactions, comprising:
having communication connecting input interfaces to at least one gateway (12) server system, to at least one of hardware, firmware, and software connecting any data and telecommunication network operator (14, 18, 28);
connecting said data and telecommunication networks (14, 18, 28) to said open secure cross-link channel system through an output communication interface in said gateway (12) server system;
connecting subscribers to mobile telephony devices (22) to said data and telecommunication operators (14, 18, 28), to said open secure cross-link channel (10) system, said subscribers devices (22) for communication having at least one identity to access said open secure cross-link channel (10) system;
storing in a memory space (30) for every subscriber in said gateway (12) server system, said memory space (30) comprising at least all information regarding said access code data, said memory space (30) being associated to said identity;
performing through at least one point said transactions by providing said access code data to said gateway (12) server;
performing a crosscheck in said gateway, checking if data belonging to said subscriber in said memory space (30) is correct by calling the identity and thus said mobile telephony device (22) associated to said memory space (30); and
if the subscriber to said identity and said crosschecked memory space (30) data, having provided said access code data, the transaction at said at least one point is granted if said subscriber grants the call and thus the transaction by returning a predetermined signal via said mobile telephony device (22).

8. A method according to claim 7, wherein said type of transaction is performed by utilizing a bank card, shopping card, petrol card, credit card and the like together with said mobile station, said cards bearing the password, wherein other card information is stored in said memory space.

9. A method according to claim 7, wherein said type of transaction is performed by a PC or like computerized device.

10. A method according to claim 7, wherein said identity is the telephone number to said mobile phone or other identity uniquely identifying the called mobile phone.

11. A method according to claim 7, wherein said memory space in addition to said access code data comprises allowed currency limit and other restricting data for ordering said services.

12. A method according to claim 7, wherein said call belongs to at least one of the following categories voice, SMS, MMS, data, and that the call and transaction is granted by entering and transmitting the signal of a predetermined PIN code.
